(19) United States
(12) Patent Application Publication
(10) Pub. No.: US 2024/0391627 A1
(43) Pub. Date: Nov. 28, 2024

(54) METHOD AND SYSTEM FOR MONITORING A JOINING PROCESS

(71) Applicant: Körber Pharma Packaging GmbH, Schloss Holte (DE)

(72) Inventors: Martin KRAUSE, Bielefeld (DE); Ulf LEINEKE, Paderborn (DE)

(21) Appl. No.: 18/672,873

(22) Filed: May 23, 2024

(30) Foreign Application Priority Data
May 26, 2023 (DE) 10 2023 113 936.3
Jun. 12, 2023 (DE) 20 2023 103 191.9

(51) Int. Cl. B65B 57/04; B65B 11/52

(52) U.S. Cl. CPC B65B 57/04; B65B 11/52

(57) ABSTRACT

A method for automatically monitoring a joining process for connecting a plurality of substrates to form a composite product under application of pressure from a pressing device comprises: acquiring measurement data which represent respective measurement values of a measurement variable for various working positions assumed by the pressing device during the application of pressure, which variable indicates a pressing force acting on the substrates during the respective working position or a variable that is dependent thereon; evaluating the acquired measurement data in order to extract therefrom a plurality of different features which each individually and/or jointly represent at least one characteristic property of a course of the measurement variable represented by the measurement data as a function of the working positions of the pressing device or a variable corresponding to the working positions; determining an evaluation indicator as a function of the extracted features; evaluating the joining process based on a juxtaposition of the evaluation indicator with an evaluation reference, by generating an evaluation result resulting from the juxtaposition, which characterizes a quality of the joining process or of the composite product produced thereby; and controlling the pressing device and/or further processing of the composite product produced by the joining process depending on the evaluation result.

### CROSS-REFERENCE TO RELATED APPLICATIONS

This application claims the benefit of German Patent Application No. 10 2023 113 936.3 filed May 26, 2023, and German Patent Application No. 20 2023 103 191.9 filed Jun. 12, 2023, the entire contents of each of which are incorporated herein by reference in their entireties.

### TECHNICAL FIELD

The present invention relates to a method, in particular a computer-implemented method for automatically monitoring a joining process for connecting a plurality of overlapping, in particular stacked, substrates to one another to form a composite product under application of pressure by a pressing device. The joining process can specifically be a sealing process for producing packaging, such as blister packs. Accordingly, the pressing device can in particular be a sealing machine, such as a plate sealing machine. The invention further relates to a data processing system configured to execute the method and to a computer program also configured to execute the method, as well as to a system having the data processing system for executing and automatically monitoring a joining process.

### BACKGROUND

In joining processes of the type mentioned above there is a risk that the quality of the resulting composite products will be impaired if there is a foreign body present between the substrates to be joined during the joining process at a point where the substrates are to be brought into contact in order to be joined, or if there is a product to be enclosed between the substrates, such as for the purpose of packaging it.

Such a case can occur in particular in the production of blister packs, for example for food or pharmaceutical or cosmetic products. Such blister packs often have a first substrate which is designed as a film with recesses formed therein for receiving the goods to be packaged, such as one tablet per recess. A second, also usually film-like, substrate is applied to the first substrate by the joining process and connected under pressure by a pressing device, in particular in a form-fitting or material-fitting manner, so that the two substrates are connected outside the regions occupied by the recesses, while the product to be packaged lies in the recesses and is surrounded on all sides by the interconnected substrates. Such a joining process is often referred to as a “sealing process” and a device configured to perform the same is referred to as a “sealing machine” or “sealing device”. The above-mentioned quality problem arises in particular when the product to be packaged, such as one or more tablets, is not properly positioned in its respective recesses during the application of pressure, but is located entirely or partially on substrate surfaces located between the recesses.

Since the occurrence of such quality problems cannot be ruled out with absolute certainty, the joining processes are usually monitored in order to detect such problems.

For this purpose, it is particularly known to measure the pressing force occurring on the pressing device during the application of pressure on the substrates to be joined during the joining process and to carry out a threshold value comparison in this regard. If the pressing force is above a predetermined threshold, it is concluded that there is an error in the joining process, whereas otherwise the joining process and the resulting connected product are considered to be error-free.

### BRIEF SUMMARY

It is an object of the invention to further improve the monitoring of joining processes of the type mentioned above.

This object is achieved according to the teaching of the independent claims. Various embodiments and developments of the solution are the subject matter of the dependent claims.

A first aspect of the solution presented here relates to a method, in particular a computer-implemented method, for automatically monitoring a joining process for connecting, in particular laminating, multiple overlapping substrates to one another to form a composite product under application of pressure by a pressing device, in particular a sealing machine, such as a plate sealing machine. The method comprises:
(i) acquiring, in particular receiving, reading in or acquiring through measurement, which represent, for different working positions assumed by the pressing device during the application of pressure, respective measurement variables of a measured, in particular scalar or vector measurement variable which indicates a pressing force acting on the substrates during the respective working position or a variable which is dependent thereon;
(ii) evaluating the acquired measurement data in order to extract therefrom, in particular to calculate, a plurality of different features which each individually and/or jointly represent at least one characteristic property of a course of the measurement variable represented by the measurement data as a function of the working positions of the pressing device or of a variable corresponding to the working positions;
(iii) determining a, particularly numerical, evaluation indicator defined as a measure of the quality of the joining process depending on the extracted features;
(iv) evaluating the joining process on the basis of a juxtaposition, for example in the form of a comparison, of the determined evaluation indicator with a defined, in particular numerical, evaluation reference, by generating a, particularly numerical, evaluation result resulting from the juxtaposition (as a measure of the quality of the joining process or of the composite product produced thereby); and
(v) controlling the pressing device and/or further treatment, in particular further processing, rejecting or marking, of the composite product produced by means of the joining process depending on the evaluation result.

The term “substrate”, as used herein, refers to a homogeneous or heterogeneous, particularly film-like or plate-like, solid (namely in a solid state at a normal temperature of 20° C. and a normal pressure of 1013 hPa), capable of being combined with one or more other of such or similar solids under application of pressure to form a composite product. In particular, a substrate can be designed as a plastic or metal film or even as a composite material itself. In particular, the different layers of a blister pack are covered by the term “substrate”, as used herein.

The term “characteristic feature” or, in short, “feature”, as used here, means a property of the course of the measurement variable, which is generally suitable for distinguishing courses of the measurement variable that occur when the joining process is faultless from other courses of the measurement variable that occur when the joining process is faulty. Such faulty embodiments may in particular concern cases in which the quality of the composite products obtained is impaired by the fact that one or more foreign bodies or products to be packaged are located between the substrates to be joined during the joining process at a point where the substrates are to be brought into contact in order to be joined. Although a feature can optionally have a direct physical meaning, it can also be just a purely calculated value without any direct meaning. What is crucial, however, is that it can be used alone or via its magnitude in combination with other features to render an anomaly that occurs during the joining process detectable.

The term “variable”, as used herein, is to be understood as a physical or chemical variable, i.e. a property of a process or state that can be quantitatively determined in a physical or chemical object. In particular, pressures, forces, electrical or mechanical stresses, material compositions or structures, mass densities, lengths, etc. are all variables in this sense.

The term “working position”, as used herein, is to be understood as a respective state of the pressing device, wherein different working positions correspond to different working points, in particular strokes or distances of pressing tools of the pressing device which exert a pressing effect on the material to be pressed (in this case substrates) during pressing.

As possibly used herein, the terms “comprises,” “contains,” “includes,” “is provided with,” “has,” “with,” or any other variant thereof are intended to cover non-exclusive inclusion. For example, a method or a device that comprises or has a list of elements is not necessarily restricted to these elements, but may include other elements that are not expressly listed or that are inherent to such a method or device.

Furthermore, unless expressly stated to the contrary, “or” refers to an inclusive or and not to an exclusive “or”. For example, a condition A or B is met by one of the following conditions: A is true (or present) and B is false (or absent), A is false (or absent) and B is true (or present), and both A and B are true (or present).

The terms “a” or “an” as possibly used herein, are defined in the meaning of “one or more”. The terms “another” and “a further” and any other variant thereof are to be understood to mean “at least another”.

The term “plurality” as possibly used herein is to be understood to mean “two or more”.

The terms “first,” “second,” “third,” and similar terms in the description and claims are used to distinguish between similar or otherwise equally named elements and are not necessarily descriptive of a sequential, spatial, or chronological order. It should be understood that the terms so used are interchangeable under appropriate circumstances, and that the embodiments of the solution described herein may operate in different orders than those described or illustrated herein.

The term “configured” or “set up” to perform a specific function (and respective modifications thereof), possibly used herein, is to be understood to mean that the corresponding device or component thereof is already provided in a design or setting in which it can execute the function or that it is at least settable-namely configurable-so that it can execute the function after corresponding setting. The configuration can take place, for example, via a corresponding setting of parameters of a process course or of switches or the like for activating or deactivating functionalities or settings. In particular, the device can have a plurality of predetermined configurations or operating modes, so that the configuration can be carried out by selecting one of these configurations or operating modes.

The method according to the first aspect is characterized in particular by the fact that a plurality of different characteristic features of the course of the measurement variable are used to evaluate the joining process. On the one hand, this has the advantage that not only directly measurable features, but also suitable features that can only be derived indirectly from the course of the process can be used for the evaluation, so that the available basis for evaluation can be expanded.

The use of a plurality of features instead of a single feature as the basis for evaluation allows an increase in the achievable reliability (or equivalently: a reduction in the error rate) and/or the accuracy of the evaluation. This allows production to be better optimized and the process yield of the joining process to be increased by reducing the number of composite products that are mistakenly classified as defective. In particular, the method is therefore not limited to the detection of very large overload situations, unlike a mere measurement of a maximum force followed by a threshold value comparison. In particular, the method is also less susceptible to any thermal expansion of components of the pressing device or the material being pressed that could distort the measurements.

Preferred exemplary embodiments of the method are described hereinafter, which in each case, unless expressly excluded or technically impossible, can be combined as desired with one another and with other aspects of the present solution, which will be described in the following.

In some embodiments, at least one of the features is selected from the following list of variables or is defined as a variable that is dependent on at least one variable from the list:
an extreme value, in particular a local or global maximum, of the course of the measurement variable corresponding to a maximum pressing force;
an indicator that identifies a working position at which the extreme value occurred;
a, in particular constant, pre-loading force to which the arrangement of the overlapping substrates was exposed by the pressing device before the pressure application for connecting the substrates with a comparatively, in particular abruptly, increased pressing force began;
an, in particular constant, post-loading force to which the arrangement of the then already joined substrates was subjected by the pressing device after the application of pressure to join the substrates with a pressing force which is increased with respect thereto occurred;
a difference or ratio between pre-loading force and post-loading force;
an indicator which identifies a working position in which, starting from the pre-loading force, the pressure application for connecting the substrates, which is carried out with a comparatively, in particular abruptly, increased pressing force, has started or has increasingly exceeded a first predetermined force threshold;
an indicator which characterizes a working position in which, after the application of pressure for joining the substrates carried out with an increased pressing force, the post-loading force began or the preceding application of pressure exceeded a second predetermined force threshold in a decreasing manner;
an integral of the measurement variable determined over its course.

A (first) variable is “in a dependency relationship” with at least one (second) variable from the list if it can be determined in a predetermined manner, in particular in the sense of a (particularly injective) mathematical function, from the at least one (second) variable from the list on which it depends. In particular, such a dependency relationship can also be defined by means of mathematical differentiation or integration.

The pre-loading and/or the post-loading can be effected in particular by means of a spring force acting on the substrates or the composite product or a gas pressure, for example in order to secure the as yet unconnected substrates against slipping relative to one another (in the case of pre-loading) or in both cases to secure the substrates or the composite product produced therefrom against slipping relative to a support. The means used to effect pre-loading and/or post-loading may in particular differ from the means used to apply pressure. For example, the pre-loading and/or post-loading can be achieved by a spring force alone, while the pressure is applied by a pressure piston or a motor-driven actuator.

The features mentioned in the list (and, where applicable, the variables that are dependent on them) have proven to be particularly suitable variables for characterizing faulty executions compared to faultless executions of the joining process using a combination of two or more of these variables.

In some embodiments, sensor data is acquired as the measurement data, wherein the sensor data has been or will be acquired based on measurements with at least one of the following sensor types: load cell, strain gauge, accelerometer. What these sensor types have in common is that they enable a direct or indirect measurement of the pressing force exerted by the pressing device on the material to be pressed as a function of its respective working position.

In some embodiments the measurement data are subjected to a preprocessing to improve the data quality, and at least one of the features is extracted from the measurement data prepared during the preprocessing. The preprocessing may in particular include filtering the measurement data to reduce or eliminate high-frequency interference. In this way, the quality of the subsequent feature extraction can be increased and, as a result, the probability of resulting erroneous evaluations can be reduced.

In some embodiments the preprocessing comprises transforming the measurement data such that the transformed measurement data continue to represent the measurement variable as a function of the working positions of the pressing device or the variable corresponding to the working positions, but are independent of the speed of the pressure applied by the pressing device (i.e. of the mathematical derivative of the pressing pressure or the pressing force with respect to time). The result of the preprocessing thus represents the measurement data, such as a force course, with reference to a speed-independent variable, such as a position of a pressing tool of the pressing device that characterizes a working position. As a result, speed plays no role in the subsequent determination of the features. Since small speed fluctuations often cannot be avoided, the transformation serves in particular to make the process even more robust against disturbances or against process fluctuations that cannot or can only be poorly controlled.

In some embodiments, the evaluation indicator is determined depending on the extracted features by weighting the features with respective assigned weight values. This can be done in particular by forming a weighted sum. The weighting of the features can be defined in particular on the basis of respective weight factors assigned individually to the features. This makes it possible to use the various features used to monitor the joining process to varying degrees in determining the evaluation indicator. In addition, if the weights can be determined variably, the evaluation indicator can be achieved, especially iteratively, as a very good approximation of an “ideal” evaluation indicator.

In some such embodiments the features are each quantified on the basis of at least one respective value from a predefined, limited set of values that is individual for each feature or the same for all features, and these values are included in the determination of the evaluation indicator with the respective assigned weight values. For example, the set of values can be given by the numerical range [0; 1]. Such standardization facilitates the implementation and efficiency of the procedure. In particular, equal or only slightly differing accuracies with regard to the quantification of the individual features can be achieved.

In some embodiments at least one of the weight values is derived based on the respective evaluation results of one or more previous executions of the joining process, wherein these evaluation results each indicate a faulty joining process. Determining the weight values based on faulty process executions allows a particularly effective and fast convergence of the weight values towards a respective ideal value. This is based on several process executions with different error causes in order to be able to correctly detect a large number of different errors later after the weight values have been determined.

In some embodiments the evaluation indicator is determined using a trained machine learning model with the extracted features as input variables of the machine learning model. An artificial neural network (ANN) is particularly suitable as a machine learning model, the parameters of which (the weights of its neurons) are optimized during training with suitable training data. In particular, the training data can comprise a large number of different data sets, each of which contains a possible value assignment of the features serving as input variables as well as a correct value for the evaluation indicator to be assigned to it. Compared to a one-time weighting scheme, the use of a machine learning model has the particular advantage that further continuous optimization of the process is available already after it has been put into operation for the first time and that even very complex weighting functions that are otherwise difficult to determine can be determined or approximated very well.

In some embodiments the juxtaposition of the determined evaluation indicator with a defined evaluation reference comprises a comparison of the determined evaluation indicator with at least one predetermined evaluation threshold serving as an evaluation reference. The evaluation indicator or the rule, such as a weighting function, for its determination can be defined in such a way that the set of values for the evaluation indicator corresponds to a specific, in particular bilaterally, limited value range (e.g. [0; 1]), so that the evaluation threshold can be determined in a simplified manner only in relation to this value range.

In some embodiments the method comprises monitoring a multiple, in particular sequential or parallel, execution of the joining process to produce a corresponding number of composite products. In addition, the evaluation is carried out for each monitored joining process. For each joining process, the respective evaluation result is stored in a data structure, in particular in a shift register, or database in such a way that the evaluation results are assigned to the respective joining processes and the respective individual evaluation results of each of the joining processes can be deduced from the contents stored in the data structure or database. Thus, the method can be extended to a plurality, in particular a large number, of process executions in such a way that the respective evaluation results, in particular several at the same time, remain at least temporarily retrievable even after the respective execution of the joining process. In particular, in the case of a production line, the evaluation results can thus “run with the composite products” along the further production process, so that they can also be evaluated for any work stations located downstream of the pressing device in the process flow, e.g. a station for the ejection of defect parts.

In some embodiments the pressing device is controlled for each joining process depending on the respective assigned evaluation result stored in the data structure or database. In particular, it is conceivable that the pressing process is stopped or carried out in a different way than in the error-free case if an error in the process execution is detected on the basis of the stored evaluation result. This can be used in particular to prevent or reduce any avoidable damage or contamination to the pressing device, for example from crushed foreign bodies or objects to be packaged.

In some embodiments the evaluation results are transmitted to a controller of the pressing device using a communication based on the known OPC Unified Architecture (OPC-UA) information model, in particular according to its version 2 (such as version 2.0), in order to enable and/or cause it to control the pressing device depending on the evaluation result. This means that the evaluation results can be transmitted in a standardized and therefore manufacturer-independent and reliable manner.

In some embodiments, a sealing machine, in particular a plate sealing machine, is used as the pressing device to join two or more of the substrates into a blister pack. Such a blister pack can be configured in particular for packaging tablet-shaped pharmaceutical products, food supplements or cosmetic products. Especially with blister packs, there is always the risk that the objects to be packaged (e.g. tablets) will end up outside the recesses provided for their inclusion, thus disrupting the joining process and leading to defects in the resulting composite product. In addition, the requirements for the integrity of such products and their packaging are usually particularly high, so that high-quality monitoring of their production and packaging is particularly relevant here.

A second aspect of the present solution relates to a data processing system for automatically monitoring a joining process, wherein the data processing system has at least one processor platform (with at least one processor) and a memory coupled thereto, in which instructions are stored which, when executed on the processor platform, cause it to carry out the method according to the first aspect, in particular according to one or more of its embodiments described herein.

A third aspect of the present solution relates to a system for carrying out and automatically monitoring a joining process for joining a plurality of overlapping substrates to one another to form a composite product under pressure by a pressing device, in particular a plate sealing machine, wherein the system comprises the pressing device including a control therefor and the data processing system according to the second aspect, which is set up to communicate evaluation results for the joining process determined by it according to the method (i.e. according to the method according to the first aspect) to the control. In particular, the data processing system and the controller may also coincide, so that the data processing system is then simultaneously configured to take over the functions of the controller.

A fourth aspect of the present solution relates to a computer program or computer program product, in particular a non-volatile computer-readable storage medium, each with instructions which, when executed on a computer or on a multi-computer platform, cause the latter to execute the method according to the first aspect.

The computer program (or the instructions) can in particular be stored on a non-volatile data carrier. Preferably, this is a data carrier of the system according to the third aspect, for example a data carrier in the form of an optical or magnetic data carrier or a flash memory module or another non-volatile semiconductor memory. In another implementation, the computer program can be present as a file on a data processing unit, in particular on a server, and can be downloaded via a data connection, such as the Internet or a dedicated data connection, such as a proprietary or local network, on the data processing system according to the second aspect. In addition, the computer program can have a plurality of interacting individual program modules. In particular, the modules can be configured or at least used in such a way that they are executed in the sense of distributed computing on different devices (such as computers or processor units) that are geographically remote from one another and connected to one another by a data network.

The features and advantages explained with respect to the first aspect of the solution also apply correspondingly to the further aspects of the solution.

The method according to the first aspect is preferably designed for execution by means of the solution-based data processing system according to the second aspect, in particular an embodiment thereof described herein. The data processing system in turn is preferably designed to carry out the method according to the first aspect, in particular an embodiment thereof described herein.

### BRIEF DESCRIPTION OF THE DRAWINGS

Further advantages, features, and possible applications of the present invention result from the following detailed description in conjunction with the figures.

In the figures:

FIG. 1 schematically shows a flowchart to illustrate an exemplary embodiment of the method for automatically monitoring a joining process;

FIG. 2A shows an exemplary temporal course of a acquired measurement variable;

FIG. 2B shows an exemplary temporal course of a position coordinate, the values of which correspond to different working positions of a pressing device used according to the method;

FIG. 2C schematically shows a preprocessing of the measurement variable from FIG. 2A and the combination of its course with the course of the position coordinate from FIG. 2B in order to obtain a course of the preprocessed measurement variable as a function of the position coordinate;

FIG. 3A shows a scheme for illustrating an extraction of various features from the course of the measurement variable, in particular according to FIG. 2C;

FIGS. 3B-D show various diagrams to illustrate the feature extraction for three different exemplary selected features;

FIG. 4A shows a flow chart illustrating a process for determining a quantified evaluation associated with a particular feature, here using the example of the feature “maximum force”;

FIG. 4B shows a numerical example of the process of FIG. 4A;

FIG. 5A shows a flow chart illustrating a process for determining an evaluation indicator for the joining process by means of a weighted sum of the respective evaluations of the individual features;

FIG. 5B is a numerical example of the process of FIG. 5A; and

FIG. 6 schematically shows an exemplary embodiment of a system for automatically monitoring a joining process set up to carry out the method from the preceding figures.

### DETAILED DESCRIPTION

In the figures, the same reference numbers denote the same, similar or corresponding elements. Elements depicted in the figures are not necessarily represented to scale. Rather, the various elements shown in the figures are presented in such a way that their function and general purpose can be understood by those skilled in the art. Connections and couplings, shown in the figures, between functional units and elements can also be implemented as an indirect connection or coupling, unless expressly stated otherwise. Unless specifically stated otherwise or technically limited to certain solutions, functional units can be implemented in particular as hardware, software or a combination of hardware and software.

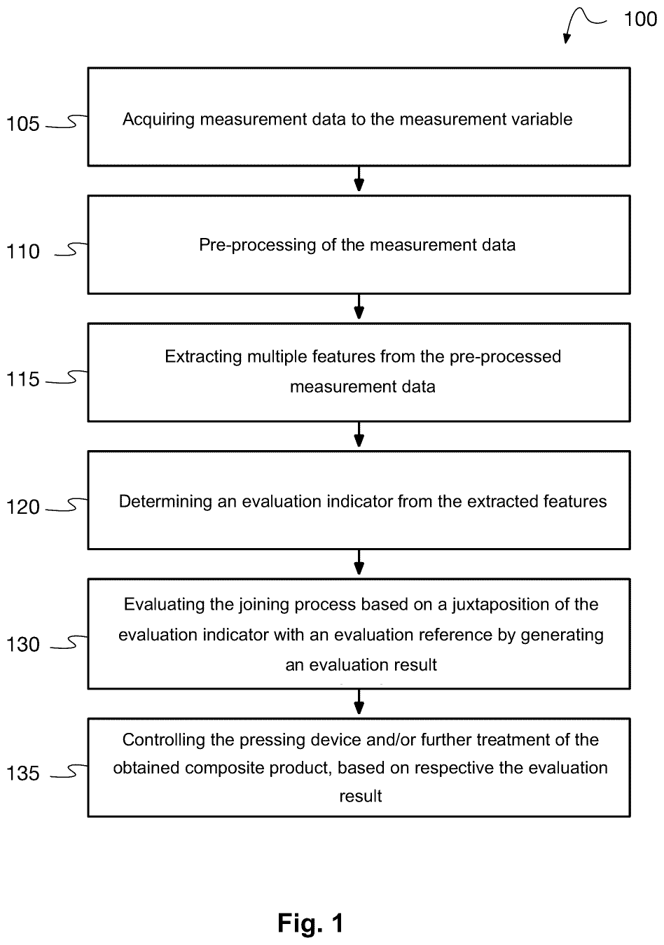

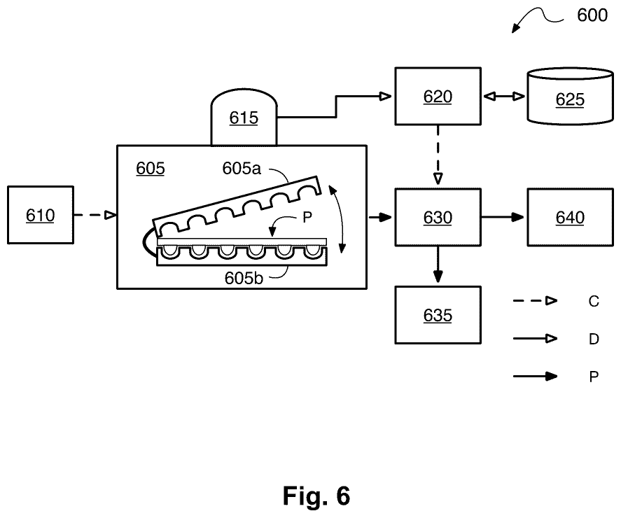

In FIG. 1 an exemplary embodiment 100 of the method for automatically monitoring a joining process is shown as a flow chart. In particular, the method 100 may be carried out by the system 600 illustrated in FIG. 6. Therefore, the method 100 is explained below with exemplary reference to the system 600, which is therefore described first.

The system 600 has a pressing device 605 for carrying out a joining process in which two or more substrates, e.g. plastic or metal films, are pressed together under pressure by means of a pressing force in order to connect the substrates in a material or form-fitting manner to form a composite product P. The pressing device 605 can in particular, as illustrated in FIG. 6, be a sealing machine, here specifically a plate sealing machine, for producing blister packs. Such blister packs can be used, for example, to package pharmaceutical products, especially tablets. Such a plate sealing machine can in particular, as shown, have two pressing tools 105a and 105b, between which the substrates to be joined are introduced in an overlapping manner, in particular stacked on top of one another, in order to then be subjected to pressure or the pressing force between the pressing tools 105a,b.

The pressing device 605 has a control unit 610 for its control by means of suitable control signals C, which unit is designed in particular by means of a programmable logic controller (PLC).

Furthermore, the system 600 has a sensor system 615 for acquiring measurement data which represent respective measurement values of a measurement variable for different working positions assumed by the pressing device 605 during the pressure application, which indicates a pressing force exerted by the pressing tools 605a, b on the substrates during the respective working position or a variable which is dependent thereon, such as a pressing pressure or an acceleration corresponding to the pressing force. The sensor types that can be used for this purpose include load cells, strain gauges and accelerometers.

The system 600 also includes a data processing system 620, such as a computer with a memory 625. The other components of the system 600 shown in FIG. 6 are introduced below in the explanation of the method 100.

To explain the method 100, reference is now made additionally to FIG. 1. The method 100 can in particular be designed as a computer-implemented method and implemented by means of a computer program that can be executed on the data processing system and stored, for example, in the memory 625.

Within the scope of the method 100, the measurement data for the at least one measurement variable are first recorded in a process 105, for which purpose the measurement data are received from the sensor system 615.

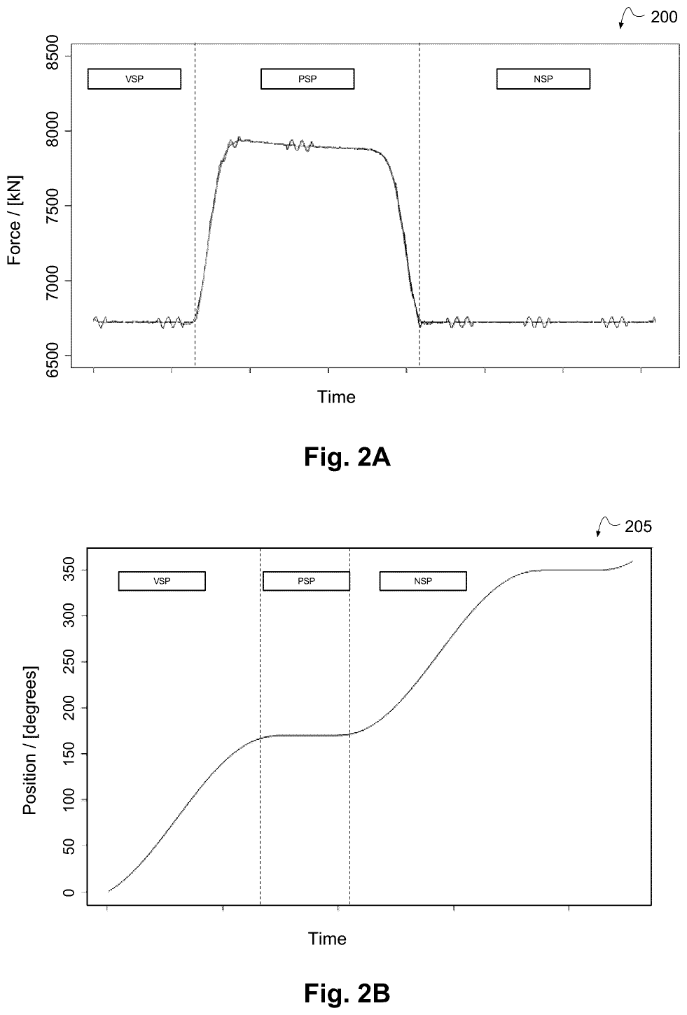

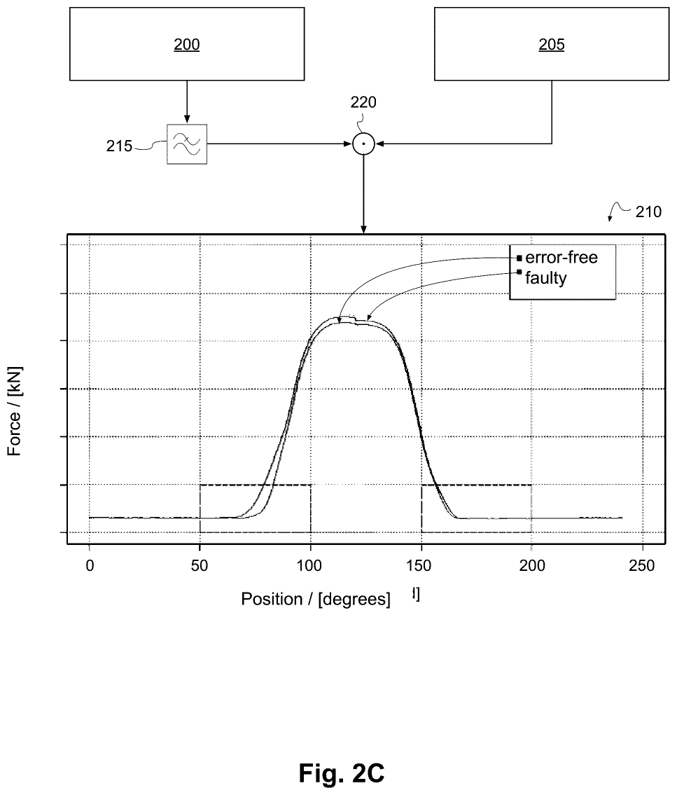

An example of a temporal course 200 of the measurement variable “pressing force” represented by acquired measurement data is illustrated in FIG. 2A. The temporal course covers a pressing process in which the substrates to be connected are first loaded against each other (“pre-loading”, VSP), then connected with an increased pressing force (pressing loading, PSP) to each other and finally remain strung against each other at a relatively lower pressing force (“post-loading”, NSP). The pre-loading can be carried out in particular (solely) by means of a spring force at a first pressing force level that is not yet sufficient to connect the substrates, wherein the then not yet connected, overlapping substrates are clamped between the tools 605a, b in order to secure them against slipping, to eliminate any air inclusions between surface portions to be connected, and/or to eliminate undesirable deformations of the substrates. The connection under pressure with a higher pressing force can be carried out with a dedicated pressing mechanism, e.g. hydraulically or by using a motor to generate the pressing force. Like the pre-loading, the post-loading can be achieved solely or at least largely by a spring force, although other designs are also conceivable.

The acquired measurement data also represent a temporal course 205 of the working position of the pressing device, illustrated by way of example in FIG. 2B, in particular the relative position of the tools 605a and 605b to one another. In this case, the range of the working positions successively assumed during the execution of the joining process can be expediently standardized, for example as in the present example to a degree range [0°; 360°] for a complete process execution, which can in particular be periodically repeatable. The term “position” is used below to indicate the position in relation to that degree range. Of course, other ways of quantifying different work positions are also possible instead.

After being acquired in process 105, the acquired measurement data are preprocessed in a further process 110, in particular as illustrated in FIG. 2C. The preprocessing may in particular comprise filtering 215 (in particular low-pass filtering) of the temporal course 200 of the measurement variable(s) represented by the measurement data in order to remove or at least reduce any interference (in particular high-frequency interference, as can be seen in FIG. 2A) therein.

During preprocessing, the (optionally filtered) course 200 and the course 205 are also linked within the framework of a transformation 220 (typically computationally) in order to obtain a course of the measurement variable(s) as a function of the working position (position). In the exemplary diagram 210 of FIG. 2C, two different courses of the measurement variable as a function of the position are already shown, wherein the course with the lower maximum corresponds to an error-free process execution, while the other course corresponds to a faulty process execution.

In particular, consider the case of a blister pack, in the production of which two substrates have to be joined together in such a way that tablets to be packaged are ideally only stored in one of the compartments formed by the substrates. The error-free progression in diagram 210 characterizes the joining process. Initially, only the essentially constant preload is applied, before the force increases significantly at a position of about 80° and reaches a maximum. Here, the two pressing tools 605a, b are pressed together as tightly as possible in order to bond the substrates, while the tablets lying in the recesses are not subjected to the pressing force. During the subsequent pressure reduction, a step in the force course occurs before the force then continuously decreases to the post-load level.

In the event of an error, however, at least one of the tablets ends up at least partially outside its associated recess, so that when the pressing tools 605a, b move together, an increase in the pressing force acting on the substrates is recorded earlier (at about) 70° than in the error-free process, because the said tablet(s) act as resistance here. The maximum force is also correspondingly higher than in the case of a faultless process and even the post-loading can begin later. The area or the integral under the courses therefore also differs. These and possibly other differences in the courses can be used below to carry out a quality evaluation of the joining process.

An advantage of the representation according to diagram 210 is that the course of the measurement variable is available independently of the speed of the process flow, so that speed fluctuations in the further course of the process are not important. The analysis of the courses can thus be carried out independently of speed.

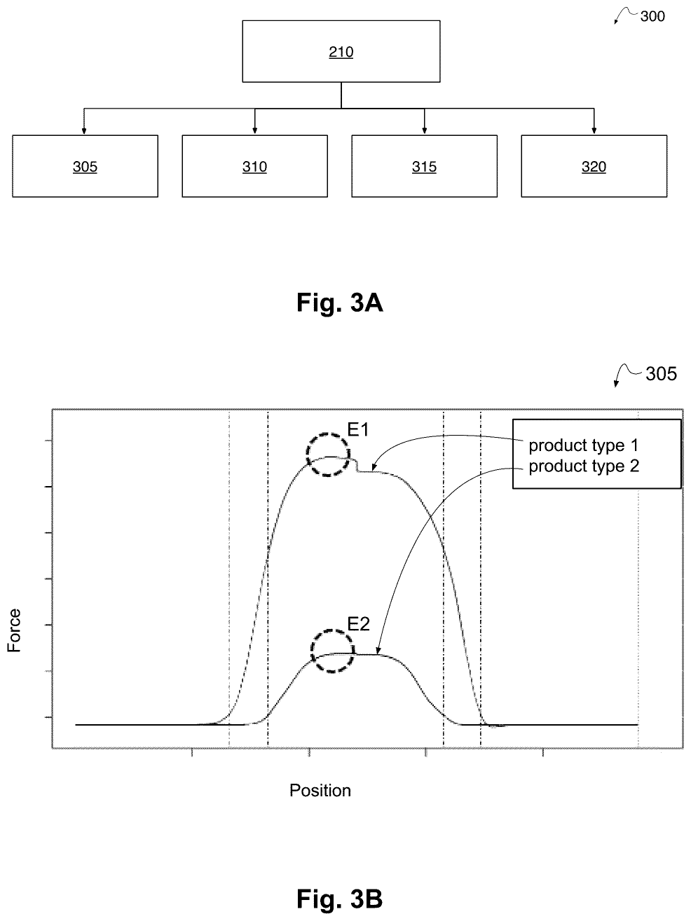

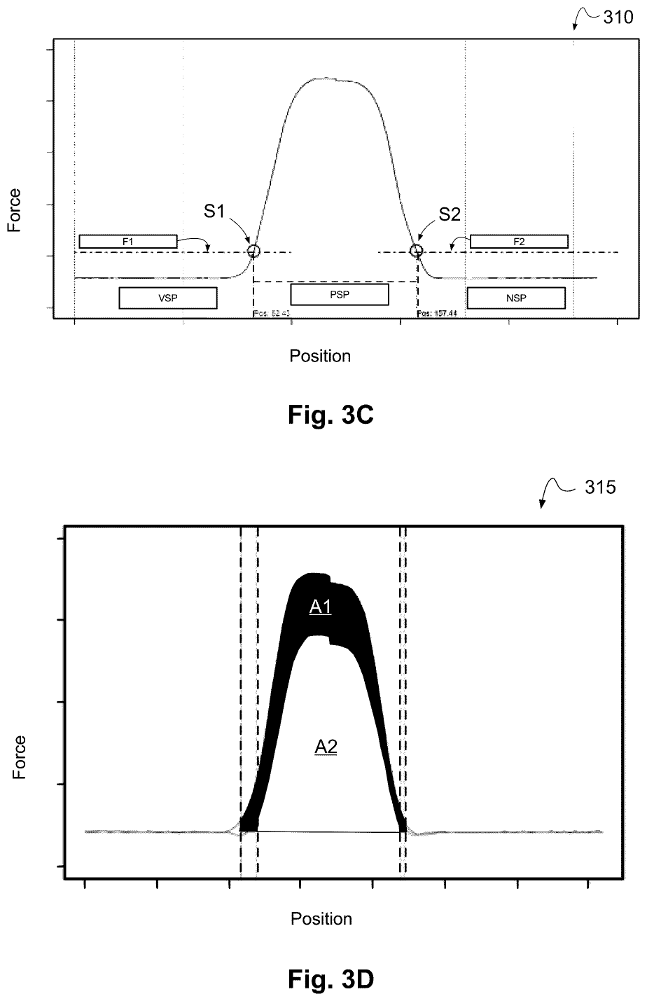

As part of the method 100, a further process 115 follows in which various features characteristic of the course 210 are extracted from the preprocessed measurement data (cf. FIG. 2C). This is illustrated in FIG. 3A, where an exemplary scheme 300 for extracting four different features in respective extraction processes 305 to 320 is shown.

FIG. 3B illustrates the extraction process 305 more precisely, in which a first feature “maximum force” is extracted, which characterizes the maximum pressing force occurring during the measurement. In FIG. 3B, a course of the pressing force corresponding to FIG. 2C is shown for two different product types, including the position of the respective maxima (extreme values) E1 and E2 occurring during the pressing phase following the pre-loading. If necessary, their position can be calculated in a known manner, in particular using differential calculus. The maxima represent the desired values for the first feature.

FIG. 3C provides a more detailed illustration of the extraction processes 310 and 315, which extract the second feature “ascending threshold exceeding” and the third feature “decreasing threshold exceeding”. These are the positions S1 and S2, respectively, where the force course starting from the preload in the ascending phase exceeds a defined increasing force threshold F1 (second feature) or exceeds a defined decreasing force threshold F2 before reaching post-load during decrease. The distance between these two positions determined in this way is also suitable as a feature.

FIG. 3D illustrates the extraction process 320 in more detail, in which a fourth feature “area integral” is extracted, which characterizes an integral under the course of the pressing force, wherein (as shown) the position ranges of the pre-load VSP and the post-load NSP can be ignored in order to achieve a higher sensitivity of the feature. In FIG. 3D, this is illustrated as an example for two different courses, where the integrals A1 and A2 are determined as areas under the courses (in this example, the area A1 also contains the area A2 as a sub-area). This can be done in a well-known way using methods of numerical integration.

Referring again to FIG. 1, in the method 100 a further process 120 follows in which an evaluation indicator for the quality of the joining process is determined from the extracted features in several stages.

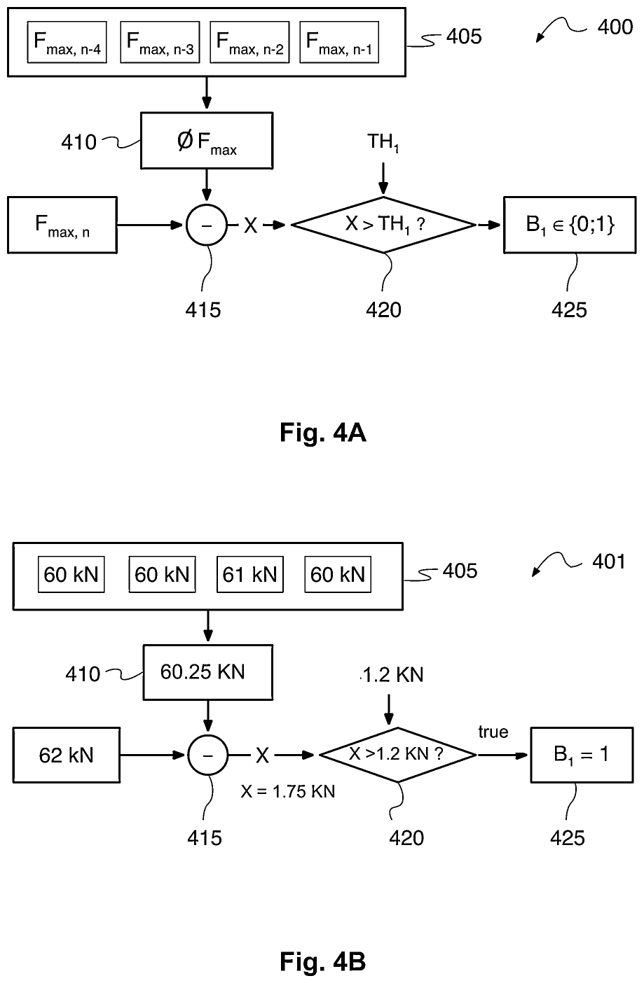

A first stage of this process 120 is illustrated in FIG. 4A and as a corresponding specific numerical example 401 in FIG. 4B. This first stage involves carrying out an individual evaluation for each of the extracted features within a process 400. In FIGS. 4A and 4B, this is shown illustratively for the first feature “maximum force” (Fₘₐₓ), but the same method can be applied to the other features.

This assumes a repeated, in particular synchronized, execution of the joining process, as is common in particular in the production of blister packs. First, in a current cycle n, a mean value Ø Fₘₐₓ is calculated in step 410 from several, in the specific example four, measurement values 405 of the immediately preceding cycles n-4 to n-1, thus the individual measurement values F_{max,n-4} to F_{max,n-1}. In a further step 415, a deviation (here specifically a difference) X between this mean value ØFₘₐₓ and a measurement value F_{max,n} taken from the measured data for the current cycle is determined. This deviation X is then compared in a step 420 with an evaluation threshold TH₁ defined for the first feature. If the deviation is higher than this valuation threshold TH₁, the feature shall be evaluated in a further step 435 with a first value (presently with B₁=“1”), otherwise with a different second value (e.g. B₁=“0”). In particular, a binary value assignment is possible here. All other features are evaluated in a corresponding manner, in particular using feature-specific individual evaluation thresholds THᵢ, in order to obtain respective evaluations B₂ to B₄.

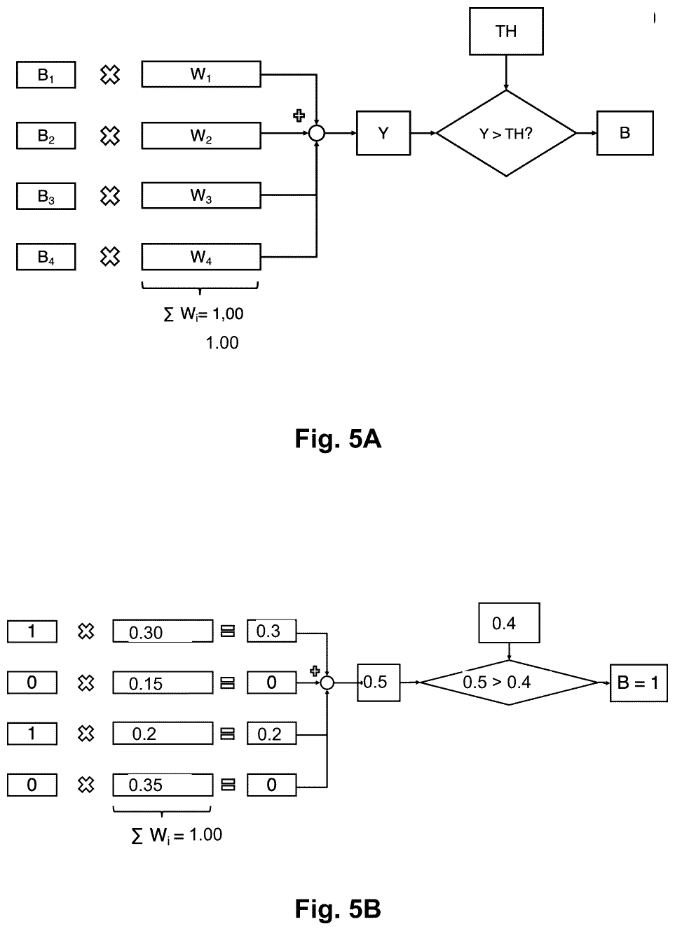

A second stage of the process 120 is illustrated in the left part of a process 500 shown in FIG. 5A and as a specific numerical example 501 in FIG. 5B. In this second stage, the values B₁ to B₄ of the extracted features determined in the first stage are each weighted with an individual weight value, in particular a respective weighting factor W₁ to W₄, and combined, which can be done in particular by forming a sum of the weighted values (Wᵢ·Bᵢ) of the features. The weighting factors W₁ to W₄ are expediently standardized according to the value range of the values B₁ to B₄ so that their sum results in the value 1. The result of the weighted sum is an evaluation indicator Y, the value of which lies in the value interval [0; 1]. Optimal values for the weight values or weighting factors, W₁ to W₄ can be determined in advance, particularly within the framework of test series. Alternatively, the evaluation indicator Y can be determined using a trained machine learning model with the values B₁ to B₄ of the extracted features as input variables of the machine learning model, wherein the weighting factors W₁ to W₄ are determined automatically during training. In particular, artificial neural networks can be used as a machine learning model.

On the basis of the evaluation indicator Y thus determined, an evaluation of the joining process can now be carried out in a further process 130 within the framework of the method 100 by juxtaposing the evaluation indicator Y with a predetermined evaluation reference, in particular an evaluation threshold TH, in particular by directly comparing, wherein as a result of the juxtaposition a corresponding evaluation result B is generated, which can be used as a quality evaluation for the joining process.

Finally, the pressing device 605 or, more generally, the system 600 and thus the further process sequence for treating the composite product P produced in the pressing device in the current cycle can then be controlled as a function of the evaluation result B within the framework of a process 135. Such a control 135 can in particular also include a (re) calibration of the pressing device. Another possibility, which can also be used cumulatively, is to separate good parts and defective parts depending on the evaluation results B for each cycle.

This is also illustrated in FIG. 6, where the system 600 further includes a rejection device 630 downstream of the pressing device 605 in the process flow, which can be controlled by the data processing device 620 depending on the evaluation result B of the current cycle in such a way that in the case of an evaluation result B that characterizes a faulty joining process, the composite product P produced is treated as a defective part and rejected from the process by the rejection device 630 and transferred, for example, to a collection depot 635 for defective parts. Otherwise, if the evaluation result B indicates an error-free joining process, the produced composite product P is treated as a good part and fed to the further process flow 640 for good parts.

In the case of the already mentioned repeated, in particular clocked, execution of the method 100, the evaluation results for each execution can be stored in particular in a data structure or database such that the evaluation results B are assigned to the respective executions of the joining process, so that the respective individual evaluation results of each of the joining processes can be inferred from the contents stored in the data structure or database. A shift register is particularly suitable as a data structure. The data structure or database can in particular be stored in the memory 625 of the system 600 and configured to be accessible for the rejection device 630 and/or for further workstations in the system 600 used along the further process flow 640. In this way, the evaluation results with the generated composite products P can be “migrated” through the process, i.e. remain available throughout. In particular, the communication of the evaluation results B within the system 600 can take place according to the OPC-UA information model (e.g. according to its version V. 2.0).

### LIST OF REFERENCE NUMERALS

100 method for monitoring a joining process
105-135 steps of method 100
200 temporal course of measurement variable “pressing force”
205 temporal course of working position of the pressing device
210 courses of measurement variable “pressing force” depending on the working position
215 pre-processing, especially (low-pass) filtering
220 transformation of the courses 200 (after pre-processing) and 205 to determine the course 210
300 feature extraction scheme
305 extraction of a first feature “maximum force”
310 Extraction of a second feature “increasing threshold exceeding”
315 Extraction of a third feature “waste threshold exceeding”
320 Extraction of a fourth feature “area integral”
400 process for individual evaluation of features, using the example of the first feature
401 numerical example for process 400
405 measured variables for (first) feature for previous work cycles
410 averaging over the measurement values 405
415 difference formation
420 comparison with feature-related threshold
425 individual evaluation of the (first) feature
500 process for determining an evaluation indicator for the joining process
501 numerical example for process 500
600 system for executing and automatically monitoring a joining process
605 pressing device, in particular sealing machine for blister packs
605a, b press tools
610 control unit of the pressing device, in particular PLC
615 sensors for detecting measurement values for measurement variable(s)
620 data processing system
625 memory, in particular program memory and/or data memory
630 rejection device
635 collection depot for rejected defective parts
640 further process flow for product parts
B evaluation indicator for joining process
Bᵢ value of the i-th feature
C control signals
D data
E1, E2 maximum force values
F_{max,j} measurement values for first feature “maximum force” with j=n-4, . . . , n−1
ØFₘₐₓ average value of the measurement values F_{max,j}
F_{max,n} current measurement values for first feature “maximum force”
F1 ascending force threshold
F2 decreasing force threshold
NSP post-loading or post-loading force
P connection product
PSP press tension
TH evaluation threshold as evaluation reference for evaluation indicator
THᵢ individual evaluation threshold for the i-th feature
VSP preloading or pre-loading force
Wᵢ weight of the i-th feature
X deviation from mean
Y weighted sum of the values of the features

1. A method for automatically monitoring a joining process for connecting a plurality of overlapping substrates to one another to form a composite product under pressure application by a pressing device, wherein the method comprises:
acquiring measurement data, which represent respective measurement values of a measurement variable for different working positions assumed by the pressing device during the application of pressure, which variable indicates a pressing force acting on the substrates during the respective working position or a variable which is dependent thereon;
evaluating the acquired measurement data in order to extract therefrom a plurality of different features, which each individually and/or jointly represent at least one characteristic property of a course of the measurement variable represented by the measurement data as a function of the working positions of the pressing device or of a variable corresponding to the working positions;
determining an evaluation indicator, defined as a measure of the quality of the joining process depending on the extracted features;
evaluating the joining process based on a juxtaposition of the determined evaluation indicator with a defined evaluation reference, by generating an evaluation result resulting from the juxtaposition; and
controlling the pressing device and/or further treating, in particular further processing, rejecting or marking, of the composite product produced by means of the joining process depending on the evaluation result.

2. The method according to claim 1, wherein at least one of the features is selected from the following list of variables or is defined as a variable that is dependent on at least one variable from the list:
an extreme value of the course of the measurement variable corresponding to a maximum pressing force;
an indicator that characterizes a working position at which the extreme value occurred;
a pre-loading force (VSP) to which the arrangement of the overlapping substrates was subjected by the pressing device before the application of pressure carried out to join the substrates with an increased pressing force was introduced;
a post-loading force (NSP) to which the arrangement of the then already joined substrates was subjected by the pressing device after the application of pressure to join the substrates with a pressing force which is increased with respect thereto;
a difference or a ratio of pre-loading force (VSP) and post-loading force (NSP);
an indicator which characterizes a working position at which, starting from the pre-loading force (VSP), the application of force for joining the substrates, carried out with an increased pressing force, started or increasingly exceeded a first predetermined force threshold;
an indicator which characterizes a working position in which, after the application of pressure for joining the substrates carried out with an increased pressing force, the post-loading force (NSP) began or the preceding application of pressure exceeded a second predetermined force threshold in a decreasing manner;
an integral of the measurement variable determined over its course.

3. The method according to claim 1, wherein sensor data are acquired as the measurement data, wherein the sensor data were or are acquired on the basis of measurements with at least one of the following sensor types: load cell, strain gauge, accelerometer.

4. The method according to claim 1, wherein the measurement data are subjected to a preprocessing to improve the data quality, and the extraction of at least one of the features occurs from the measurement data prepared during the preprocessing.

5. The method according to claim 4, wherein the preprocessing comprises filtering the measurement data to reduce or eliminate high-frequency interference.

6. The method according to claim 4, wherein the preprocessing comprises transforming the measurement data such that the transformed measurement data continue to represent the measurement variable as a function of the working positions of the pressing device or the variable corresponding to the working positions, but are independent of the speed of the application of pressure applied by the pressing device.

7. The method according to claim 1, wherein the determination of the evaluation indicator is carried out as a function of the extracted features by weighting the features with respective assigned weight values.

8. The method according to claim 7, wherein the features are each quantified on the basis of at least one respective value from a respective predefined, limited set of values that is individual for each feature or the same for all features, and these values are included in the determination of the evaluation indicator together with the respective assigned weight values.

9. The method according to claim 7, wherein at least one of the weight values is derived based on the respective evaluation results of one or more previous executions of the joining process, wherein these evaluation results each indicate a faulty joining process.

10. The method according to claim 1, wherein the determination of the evaluation indicator is carried out using a trained machine learning model with the extracted features as input variables of the machine learning model.

11. The method according to claim 1, wherein the juxtaposition of the determined evaluation indicator with a defined evaluation reference comprises a comparison of the determined evaluation indicator with at least one predetermined evaluation threshold serving as an evaluation reference.

12. The method according to claim 1, wherein:
the method comprises monitoring a multiple execution of the joining process to produce a corresponding number of composite products; and
the evaluation is performed for each monitored joining process, wherein for each joining process, the respective evaluation result is stored in a data structure or database in such a way that the evaluation results are assigned to the respective joining processes so that, from the contents stored in the data structure or data base, the respective individual evaluation results of each of the joining processes can be deduced.

13. The method according to claim 1, wherein the control of the pressing device for each joining process takes place as a function of the respective assigned evaluation result stored in the data structure or database.

14. The method according to claim 1, wherein the evaluation results are transmitted to a controller of the pressing device using a communication based on the OPC-UA information model in order to enable and/or cause it to control the pressing device depending on the evaluation result.

15. The method according to claim 1, wherein a sealing machine is used as the pressing device to combine two or more of the substrates into a blister pack.

16. A data processing system for automatically monitoring a joining process, wherein the data processing system has at least one processor platform and a memory coupled thereto, in which instructions are stored which, when executed on the processor platform, cause it to carry out the method according to claim 1.

17. A system for carrying out and automatically monitoring a joining process for connecting a plurality of overlapping substrates to one another to form a composite product under pressure by application of pressure by a pressing device, wherein the system comprises the pressing device including a controller therefor and the data processing system according to claim 16, which is configured to communicate evaluation results for the joining process determined by it in accordance with the method to the controller.

18. A computer program or computer program product, in particular a non-transitory computer-readable storage medium, with respective instructions which, when executed on a data processing system, cause it to perform a method according to claim 1.

19. A computer program or computer program product, in particular a non-transitory computer-readable storage medium, with respective instructions which, when executed on a data processing system, cause it to perform a method according to claim 2.

20. A computer program or computer program product, in particular a non-transitory computer-readable storage medium, with respective instructions which, when executed on a data processing system, cause it to perform a method according to claim 3.
